(19) United States
(12) Patent Application Publication
(10) Pub. No.: US 2008/0229585 A1
(43) Pub. Date: Sep. 25, 2008

(54) Seasoning spoon

(76) Inventor: Robert Kelly, Burlingame, CA (US)

Correspondence Address: MORGAN, LEWIS & BOCKIUS, LLP, ONE MARKET SPEAR STREET TOWER, SAN FRANCISCO, CA, 94105, US

(21) Appl. No.: 12/052,566

(22) Filed: Mar. 20, 2008

Related U.S. Application Data
(60) Provisional application No. 60/896,367, filed on Mar. 22, 2007.

(51) Int. Cl. B26B 11/00

(52) U.S. Cl. 30/125; 30/123; 30/142

(57) ABSTRACT

A device with a housing that contains chambers for holding and dispensing seasonings that contains an opening for attaching and removing a cooking adjunct.

### CROSS-REFERENCE TO RELATED APPLICATION

This application claims the benefit, under 35 USC 119(e), of U.S. Provisional Application No. 60/896,367 filed on Mar. 22, 2007.

### FIELD OF THE INVENTION

The invention relates to a novel device that assists in the preparation, seasoning, cooking and serving of food by various methods.

### BACKGROUND OF THE INVENTION

Since man first learned to generate and control heat he has exploited its properties for both necessary and novel means. Besides a warm environment heat provides a primary method and means of making food safe for consumption by sterilizing it as it cooks, whether through the boiling of water, frying on a stove top, baking in an oven, coals under a bar-b-que grill or other means. Cooking food requires constant monitoring of the fare, and to avoid over or under cooking the provisions must be moved, stirred, turned or otherwise cared for. During this process it is often desirable to season the food using spices, sauce or other extracts. While no one can argue that there is not a multitude of spoons, spatulas, forks and other utensils available, as well as an endless selection of spices and seasons; a problem exists during this cooking and flavoring process in the ability to have such seasoning readily available while coinciding with tending to the progression of the meal with the proper utensil. One example is while cooking on a stove top with a covered pan. The cook must first lift the heated cover off, stir or rotate the cooking items, and season them before returning the cover. This procedure may call for securing the hot lid and making several passes back and forth across a heated area to grab various containers of salt, pepper or other seasoning as well as the cooking utensil. This is both time consuming and potentially dangerous. Another problem exists where cooking is taking place on multiple surfaces, such as an oven and stove top, or in multiple areas such as indoors and outdoors. The cook must bring a utensil and a cache of seasonings to a series of locations, which again is an inconvenient process for the consumer. An additional problem exists where there is no table or counter top to set seasonings on, and the items have to be carried in pockets or placed on the ground near or below a hot area. Various products have attempted to address these problems by having multiple seasonings in small packages or dispensers, mixing seasonings and spices together, and the creation of various types of utensils for cooking assistance. An example of this would be Somerset (U.S. Pat. No. 4,711,029) who teaches a spatula with prongs and (Kushner (U.S. Pat. No. D524, 125 S) who teaches a spatula with removable seasoning dispensers. While a spatula may be suited for certain types of cooking, alternate food types may require different adjuncts (e.g. a slotted spoon for certain sauce preparations), and adjuncts with prongs or other surfaces may not be desirable (e.g. a Teflon® coated pan which may scratch). Ceccarelli (U.S. Pat. No. 3,931,741) teaches a removable spoon that fits into a housing, however; the consumer may be desirable of the convenience of several different attachments. Also, the consumer may desire easier access to distribute seasonings. In addition, the consumer may desire a permanent refillable chamber as opposed to small removable dispensers which may be misplaced of lost. Holcomb (U.S. Pat. No. 4,573,244) teaches a handle shaped grinder and dispenser that allows visualization of seasonings but is limited to two compartments.

The Sensational Seasoning Spoon (the device) better solves these problems by incorporating the desired seasonings into the handle of a gadget which not only allows the consumer to reposition or serve his food with a multitude of attachments but to season it at the same time. Flavoring foods is as easy as passing the device over the cuisine as the seasoning is released from chambers located within the handle, making it a simple, one-handed operation. This not only saves time, but also makes cooking safer as one can simply lift a lid off a pot or a bar-b-que, attend to the food including adding seasoning or sauce, and return the lid without having to either place it down or repeatedly pick up different seasonings causing one to lose focus of personal safety. In the case where there is no table, none is necessary as the needed seasonings are in hand. And, since the handle has different attachments, the consumer can chose which cooking adjunct is best suited and the safest for the preparation, cooking and serving of provisions.

### SUMMARY OF THE INVENTION

The Sensational Seasoning Spoon is a multipurpose, multiuse device that holds and distributes food seasonings, spices and condiments and from its handle and has a number of different utensil attachments that quickly interchange for various cooking activity.

### BRIEF DESCRIPTION OF THE DRAWINGS

FIG. 1 depicts the device with a spatula shaped attachment adjunct in an unassembled state.

FIG. 2 depicts the device handle with an adjunct end secured in place.

FIG. 3 depicts the device handle with the locking pin for adjuncts and chamber covers removed.

FIG. 4 depicts a spoon or ladle attachment adjunct.

FIG. 5 depicts a slotted or spoon with drain holes attachment adjunct.

FIG. 6 depicts a fork shaped attachment adjunct.

### DETAILED DESCRIPTION OF THE INVENTION

The present invention provides a means to conveniently attend to food as it is prepared, cooked and served by allowing the consumer to move, turn, flip, spoon or otherwise tend to food and also season it using desired spices located and distributed from the handle. In general the device consists of a handle with multiple chambers for dispensing seasonings and a number of different attachment adjuncts for tending to food as it is prepared, cook and/or served.

In the preferred embodiment the device will consist of a handle with one or more see-through chambers and removable attachments which may include one or more of the following: a spoon, spatula, draining spoon (e.g. with slots or holes), two prong fork, spaghetti fork or other commonly used food preparation adjunct. The handle would ideally be constructed of clear acrylic or to allow visualization of the type and amount of seasonings in each chamber, although plastics, resins, or other polymer may also be suitable, as well as metals such as stainless steel, copper or similar smooth metals. The handle would be ergonomically designed to allow a comfortable grip by the user, and may have ridges or rubber, silicone or similar covering to enhance grip and safety. Each chamber would have a cover that opens to facilitate easy filling of the chambers (e.g. a screw cap, latch, plug, cork or cap or similar removable piece). Each chamber will have the ability to easily distribute seasoning by the operator. This distribution of seasonings will take place by pressing a button or pulling a trigger or lever in the preferred embodiment, with the buttons and/or trigger or lever located in such a manner as to be easily accessible to a user regardless of their dominant hand. Once activated dispensing holes will allow a controlled release of product onto the food. Other methods may include squeezing a handle, sliding a lid or any other operation that will distribute the desired amount of product. Further embodiments may include built in gadgets such as a pepper grinder or cheese grater (e.g. for adding freshly ground pepper and grated cheese to a salad using a spoon or salad fork attachment). The attachments would preferably be constructed with a flexible heat resistant material such as Teflon®, although nylon, resins, plastics, or any combination or mix of materials may also be desirable.

The handle will also have a number of interchangeable utensils that fit into a standard slot, such as but not limited to a spatula, fork, spoon, slotted spoon, whip, masher, skewer or other cooking adjunct. These utensils will lock into the handle with in such a manner as to be secure and safe for use (e.g. a prong, pin, or spring loaded ball), but also be easily removed by the consumer for cleaning or changing the desired attachment. Under certain applications the device may also be constructed in such a manner as to distribute seasonings such as a sauce which may come prepackaged in a container or a cartridge that fits into the handle. Examples of this would be a cylindrical squeeze handle that could be filled with bar-b-que sauce or an attachment designed to screw onto or attach to a pre made container of sauce (e.g. a tube of bar-b-que sauce that comes with an attachment adjunct).

Those skilled in the art will appreciate that attachment adjuncts will be designed as to allow for easy cleaning by the consumer (e.g. top rack dishwasher safe) and that the handle with covers will be water resistant or in other embodiments water tight.

In other embodiments the device may come as a single utensil pre-loaded with desirable spices or condiments for the consumer, such as a disposable unit used for camping or other travel use, or a brush with sauce or other seasoning pre loaded into the handle. In further embodiments the device may come as part of a kit, such as a travel bar-b-que, or packaged with a food item that compliments it (e.g. a disposable spatula with seasoning packaged with pre-made hamburgers or a brush with a container of sauce or other condiments in a squeeze handle). In other embodiments the device may have a manual or battery power source contained in the handle for activating motor driven seasonings (e.g. pepper grinder) or other favorable adjuncts (such as a light emitting diode for night use). In still further embodiments the handle and attachments may be made partially or completely of recycled materials that will allow the product to again be recycled after use and thus benefit the environment.

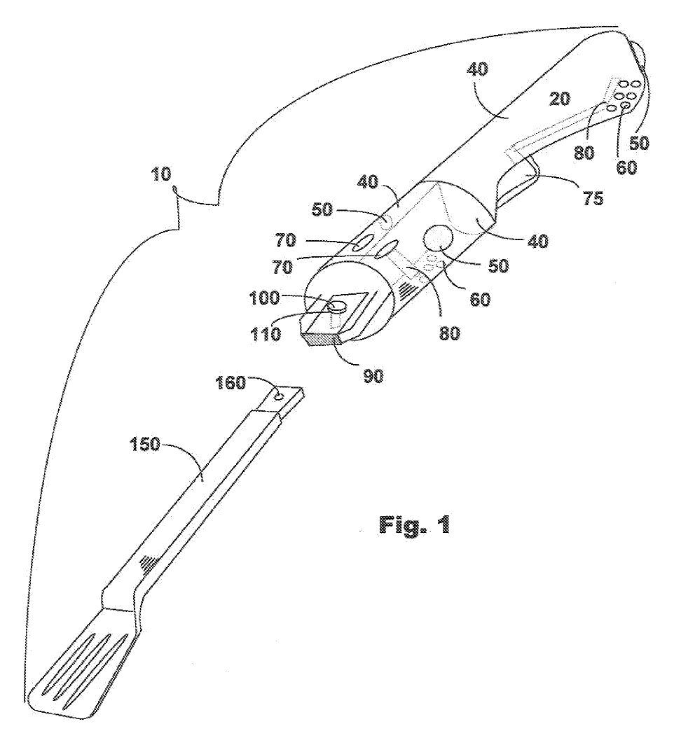

In FIG. 1 reference is made to the device 10 consisting of the handle 20 and attachment adjunct 150, which is shown as a spatula but may vary in design at one end, and has locking pin hole 160 at the other end. The handle 20 has three chambers 40. Each chamber 40 has an opening 45, and cover 50, dispensing holes 60 and an activation button 70. The activation button 70 opens the dispensing hole cover 80 to allow the desired product to be gradually released. Those skilled in the art may appreciate that the activation button could be spring loaded, use a plastic tab or slide, or open a retractable latch. Reference is also made to the attachment slot 90 which accepts the attachment adjunct 150 into the handle 20 and is held in place using by aligning locking pin hole 160 with the locking pin receiver 110 and inserting locking pin 100 into the aligned holes.

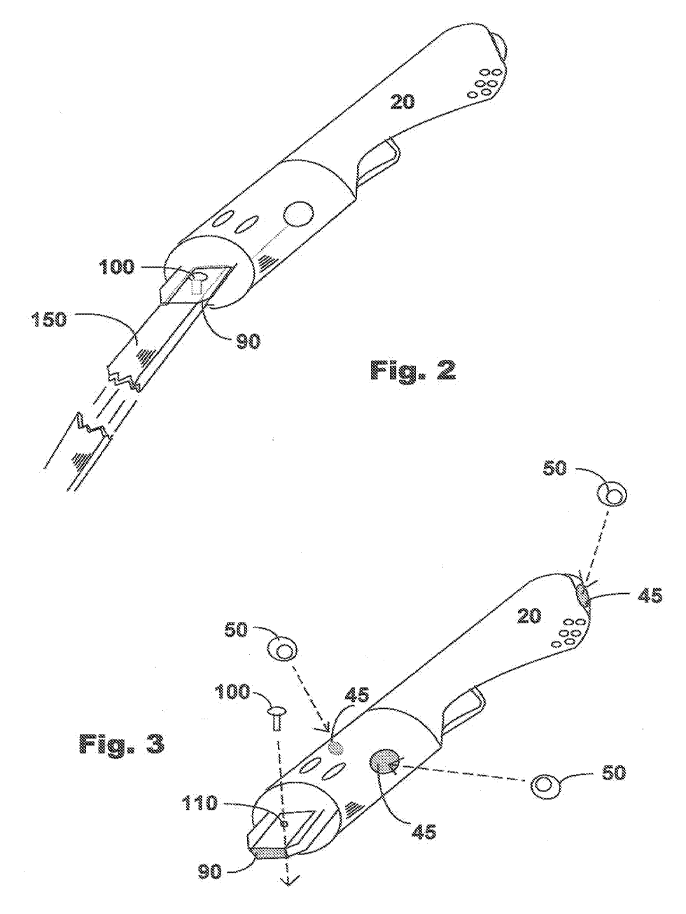

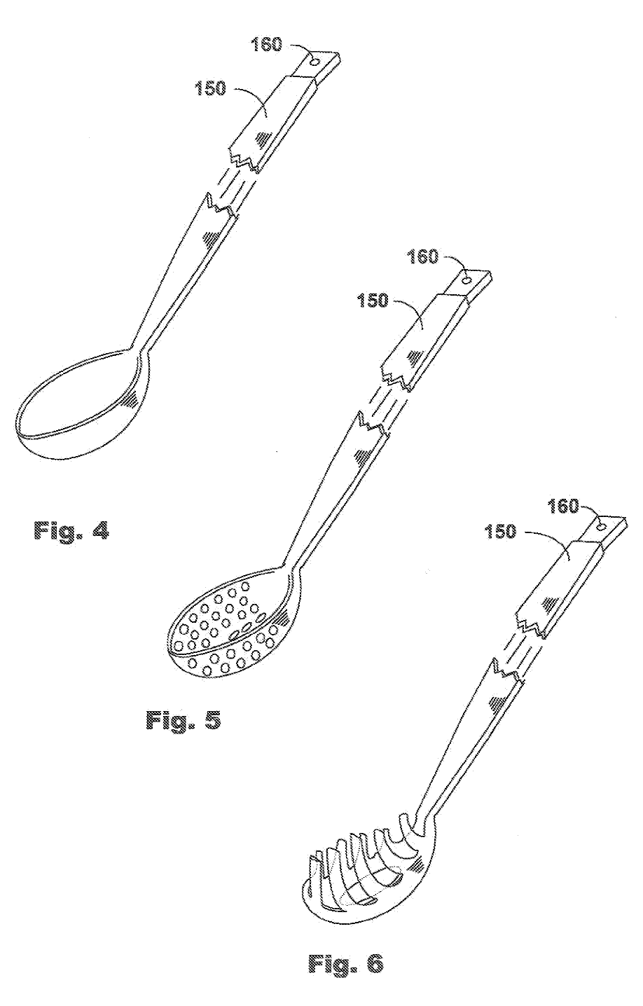

In FIG. 2 reference is made to the attachment adjunct 150, which may be of any length as to be advantageous to the consumer and may also have several different configurations. The attachment handle end is shown inserted in place into the attachment slot 90 of the handle 20, with pin 100 extending through the locking pin receiver hole and locking pin hole as previously referenced in FIG. 1.

In FIG. 3 reference is again made to the handle 20 showing chamber openings 45 with chamber covers 50 removed, as well as the adjunct locking pin 100 removed from the locking pin receiver 110 which runs through the attachment slot 90.

In FIG. 5 the attachment adjunct 150 is shown in the shape of a spoon or ladle at one end and locking pin hole 160 at the other end.

In FIG. 6 the attachment adjunct 150 is shown in the shape of a slotted, hole, or draining spoon at one end and locking pin hole 160 at the other end.

Also included is the attachment adjunct 150 in the shape of a multi-pronged fork.

I claim:

1. A device with a housing that contains chambers for holding and dispensing seasonings that contains an opening for attaching and removing a cooking adjunct.

2. The device in claim 1 where the attachable cooking adjunct is a spatula, spoon, slotted spoon, fork, masher, whisk, ladle, tongs or knife.

3. The device in claim 1 where the housing includes a multitude of chambers and a cheese grater.

4. The device in claim 1 where the housing includes a multitude of chambers and a pepper grinder.

5. A kit that contains the device in claim 1 and the one or more of the adjuncts named in claim 2.

6. The device in claim 1 where one of the chambers can be compressed or squeezed.

7. A kit that contains the device in claim 1 and one of the adjuncts named in claim 2 where the housing is pre filled with a sauce or seasoning.

8. The device in claim 1 and one or more of the adjuncts in claim 2 where the housing accepts one or more pre-filled seasoning or sauce containers.
